(19) United States
(12) Patent Application Publication
(10) Pub. No.: US 2009/0166906 A1
(43) Pub. Date: Jul. 2, 2009

(54) Device and process for compression particles

(76) Inventors: Andreas Strasser, Neckarsteinach (DE); Alexander Cross, Mainz (DE)

Correspondence Address: Stephen D. Scanlon;Jones Day, 901 Lakeside Avenue, Cleveland, OH, 44114, US

(21) Appl. No.: 11/661,071

(22) PCT Filed: Aug. 23, 2005
(86) PCT No.: PCT/EP2005/009100

§ 371 Date: Sep. 19, 2007

(30) Foreign Application Priority Data
Aug. 24, 2004 (DE) 10 2004 040 939.0

(51) Int. Cl. B29C 43/58; B30B 11/02

(52) U.S. Cl. 264/40.1; 425/258

(57) ABSTRACT

The present invention concerns a device (10) for the manufacture of compressed particle beds having a container (22) for receiving particles respectively materials in particle form, a guiding device (14) for the support and guidance of the container (22) and a compression equipment (22), whereby the compression equipment (20) is in effective connection with the container (22).

The present invention concerns a device as well as a process for the controlled production of compressed particle beds.

The present invention is in the technical field of the high throughput catalyst research, in particular the high throughput material research. It is well-known that by the use of such high throughput methods the efficiency respectively the effectiveness for the finding of new materials can be significantly increased for certain purposes. Among other things it is important to significantly increase the manufacture rate already in the production of the appropriate materials, e.g. in the production of heterogeneous catalysts, whereby the reproducibility of the manufacturing process and the realization and the obtainment of precisely defined products have particularly significant importance. For example, this is necessary in the manufacture of heterogeneous catalysts, because in the following catalyst screening reliable test conditions can be obtained only, if the heterogeneous catalysts, which in the present instance are pre-sent in the form of compressed particle beds as fixed bed catalysts, are employed with a pre-determined degree of compression. Thereby, it is favourable to manufacture those materials the heterogeneous catalysts are based on (compressed particle beds), also in parallel, preferably fully automated in parallel.

In many technical investigations such as in the testing of catalysts and in analytical tests, the generation of measuring data is based on an inclusion of powdery respectively materials in the form of particles, which must be present during the realization of the process in the form of compressed particle packings in containers. The characteristics of a particle packing and the reproducibility of the manufacture of particle packings are crucial factors, which substantially affect the quality of the measuring data.

The compression of particles in containers by means of ramming devices is known. Thereby, the ramming devices consist of a sample container which is subjected to a hammer-like flapping motion by means of an electric motor drive. The application range for such ramming devices consists in the physical characterisation of particles. The containers equipped with uncompressed particles are moved by means of the ramming equipment, whereby the ramming time and the ramming rate are predetermined. After a container filled with particles was subjected to a sufficient ramming treatment, at first the particle bed is compressed and takes a certain volume, which possesses a characteristic size as a function of the respective sample. Using the parameters weighted sample and sample volume, the ramming density of the sample can be calculated after the ramming of the container.

Furthermore, it is known to accomplish the compression of particle beds in containers by means of vibrating the containers whereby the containers filled with powder respectively with particles are treated alternatively by means of mechanical vibrators or ultrasonic probes.

For the manufacture of powder packings respectively particle packings in the form of columns or cylinders for applications in the fields of the chromatography and the catalysis, methods by means of vibrators are generally established.

However, the tube packings that are manufactured in such a way have several drawbacks. That predominantly serially accomplished manufacture of packings is very time-consuming, and the compression of the particle beds that are employed is not sufficiently high enough. Besides, the reproducibility of the column packings manufactured according to conventional processes has limitations, which make a reduction of test devices more difficult for catalytic and chromatographical investigations. Due to the unsatisfying reproducibility in the packing of columns, the manufacture of complex designed column packings is extremely limited. The parallelisation of the process for the packing of columns using vibrators is technically associated with a very high complexity.

Therefore, one object of the present invention consisted in providing a device and a process with what a faster manufacture of compressed particle packings is possible, whereby the particle packings exhibit a higher compression, the reproducibility is improved, the size of the test equipment in which the compressed particle packings are used, is reduced and thus a parallelisation of several devices can be achieved.

These and further objects are solved by a device for the manufacture of compressed particle beds having a container for receiving particles, a guiding device for the support and guidance of the container, and by a compression equipment, whereby the compression equipment is in effective connection with the container.

Further, the device according to the invention can have an adjustable arrester, which preferably is multidimensionally adjustable. Here, exemplarily, the combination of a linear uniaxial adjustment with a pivotable adjustment around a rotation axis is mentioned. Furthermore, the arrester can be formed in such a manner that apart from the adjustability a complete removal of the arrester is possible. Furthermore, the arrester preferably has clamping means, with which the arrester is fixable in predetermined positions. Furthermore, the arrester is suitable to cooperate with means for the guidance thereof.

Furthermore, the device according to the invention can have one or more guiding devices for several containers, whereby the compression equipment preferably has one or more reciprocating pistons. This form that is aimed for, in particular under the criterion of parallelisation, makes it possible to manufacture a larger number of compressed particle beds in parallel. Preferably, thereby, in each case a container is in effective connection with a reciprocating piston, respectively, or several containers are in effective connection with a reciprocating piston. The number of containers is thereby preferentially within the range of from 2 to 1.000, in particular within the range of from 2 to 100.

Furthermore, the compression equipment of the device according to the invention preferably has one or more magnetic valves. The one or the more reciprocating pistons of the compression equipment of the present invention are preferentially pneumatically operated. Thereby, by means of the magnetic valves, preferably the supply of the pneumatic medium is controlled with respect to the reciprocating piston.

Furthermore, the containers of the device according to the invention preferably have a closing respectively several closings, which preferably are gas-permeable. In a preferred embodiment, the containers are tubular reactors, which have such a gas-permeable closing at least on one side. For example, such a closing can be a frit or a fine-mesh wire net, whereby the discharge of the particles being present in the containers is prevented. Furthermore, the compression process can be strengthened respectively supported, if a negative pressure is applied at the gas-permeable end side of the container by means of a vacuum pump.

In a further preferred embodiment, the guiding device of the device according to the invention can likewise have a closing, whereby this closing can replace the function of the arrester. Thereby, after inserting the container into the guiding device, said device is closed on one side by the closing. Thereby, the closing preferably is on the side opposite to the reciprocating piston. Further, the guiding device can be arranged in several parts, whereby a similar function of the closing respectively the arrester is achieved. In this connection, for example, a tubular structure would be conceivable, with which two pipes of different diameter are coaxially adjustable and fixable against each other, whereby one pipe is designed such that it is closed on one side, and thus adopts the arrester function.

The motion direction of the reciprocating piston as well as of the container of the device according to the invention is preferentially vertical. Thus, the use of spring elements can be waived since the one container or the more containers fall back again on the reciprocating piston due to the gravity and due to a recoil impulse which is exerted on the containers by the arrester. A horizontal motion of the reciprocating piston respectively a motion direction of the reciprocating piston being different from the vertical motion is likewise possible, whereby moving the container backward from the arrester to the reciprocating piston can be additionally supported to the recoil impulse by means of spring elements.

Preferably, the present invention has a data-processing system. With this data-processing system the control respectively the regulation of the entire device respectively individual components as well as the process according to the invention are possible, which in the following are described more detailed.

The particle size of the particles to be compressed preferably is in the particle size range of from 4 μm to 5.000 μm, in particular within a particle size range of from 40 μm to 600 μm.

Apart from the already described device, the present invention concerns a process for the manufacture of compressed particle beds, which comprises the steps
(a) filling a container with a first material in particle form,
(b) closing the container, and
(c) compressing the first material in particle form,
whereby a reciprocating piston exerts on the container such that the container is accelerated in a guiding device towards an arrester, and, after striking the arrester, moves back again towards the reciprocating piston.

This motion sequence of the container is repeated according to a certain stroke rate until a pre-defined degree of compression of the first material in particle form is achieved. For example, the stroke number as well as the stroke rate can be varied by the data-processing system according to the achieved degree of compression in dependence to the pre-defined degree of compression.

The process according to the invention can be repeated according to the steps (a) to (c) with one or more further materials in particle form. Thereby, the steps (a) to (c) with the further materials in particle form are preferably accomplished with one container, respectively. Further, it is possible to successively fill and compress a container having different materials in particle form, and also the successive compressing of each individual material in particle form within a container, in order to achieve a layered and compressed particle bed. In particular, for a clean layering of the individual materials in particle form, it is preferred to realize the steps (a) to (c) one after the other with each individual material in particle form.

In the process according to the invention, the steps (a) to (c) are preferably accomplished with several containers in parallel. Therefore, this is particularly important, since the present process is used in the high throughput catalyst research, and in which a high number of catalyst samples in the form of compressed particle beds are needed having the same compression characteristics.

Preferably, in the process according to the invention, the reciprocating pistons provide a stroke rate within the range of from 200 to 1.200 strokes per minute. Having a stroke rate within this range, depending upon kind and quantity of the material in particle form to be compressed, the best compression results are achieved. However, a stroke rate outside of this range is likewise conceivable.

The energy acting on the material in particle form during the compression preferably is given by predetermined parameters. These parameters preferably are selected from the group: motion rate of the piston, acceleration of the piston, frequency of the piston strokes, distance of container to arrester, elasticity of the arrester material, container material and material of the reciprocating piston, total stroke number as well as stroke force of the piston. This enumerating is not limiting. The enumerated parameters preferably are predetermined by means of the data-processing system on the basis of saved set points for the respective kind of particle and particle quantity, and are varied during the process depending upon the degree of compression to be achieved, what can be achieved by means of the control respectively the regulation of the device respectively of individual components thereof.

For the process according to the invention, it is further characteristical that the particles respectively the material in particle form are compressed in one or the more containers by means of an inhomogeneous motion and/or a harmonic wave-rich oscillation.

In this context it is pointed out that the characteristics of the materials in particle form—such as for example particle size, particle size distribution and density—crucially effect the compression process. The particle sizes of the particles to be compressed generally are in a range of from 4 μm to 5.000 μm, whereby a particle size range of from 40 μm to 600 μm is preferred. An individual material in particle form can exhibit different characteristics concerning the particle size distributions and density, in particular towards another material. The experimental conditions should be selected such that with the execution of the test a separation of the materials in the form of particles is preferably excluded.

In the process according to the invention, it is particularly preferred to automatedly transfer and to remove the container or the containers into the device or from the device together with the materials in the form of particles. Thereby, the device according to the invention can be automated such that the containers are processed serially in an automated manner, for example with a grab arm for inserting respectively removing the containers, which, for example, are made available by means of a conveyer belt. Thereby, in the device according to invention, when inserting or removing the containers in or from the device as well as outside from the device, the containers can be automatedly handled individually one after the other, or several containers can be handled in parallel.

Furthermore, the present invention concerns a computer program having program code means for the control or regulation of the device according to the invention or for the realization of the process according to the invention as well as data carriers having said computer program. For example, the parameters as well as sequence routines are saved on this data carrier which are accomplished in reference experiments, which by means of the computer program and the data-processing system serve for the control respectively regulation of the device and the process.

The process according to the invention is based among other things on the fact that containers filled with materials in particle form are exposed to a preferably mechanical energy effect by means of the device according to the invention. In particular the energy effect on the containers filled with particles is controlled by means of the control or the regulation of the device according to the invention, so that the degree of compression of the particle bed and the time for achieving the desired degree of compression can exactly be pre-determined. By the repeated application of the process on one or more containers, which are successively filled with different types of particles, a structure of complex packing structures (in particular structured beds having layered structures) is possible. Furthermore, a compression of the different particle types having each different degrees of compression is possible. Thereby, each particle type in a container is compressed to another degree of compression. This is naturally also possible with only one particle type per container, which is compressed in several successively accomplished steps (a) to (c) having a different degree of compression.

The energy, which acts on the container filled with materials in particle form is predetermined by several control parameters. Thereby, the preferred control parameters involve the speed of the pneumatically driven piston, the number of the piston strokes per time unit as well as the distance of the upper edge of the container filled with particles up to the stop plate. Moreover, also the material and the elasticity of the stop plate can be predetermined. The use of the stop plate for the transmission of a recoil impulse on the container, which preferably is in the form of a tubular reactor, in particular in the form of a liner, makes it possible that the container filled with particles experiences the double number of arrests compared to a container moved with ramming devices during an entire motion cycle. With ramming devices only the ramming piston moves, however not the container with the material in particle form to be compressed, whereby the material in the form of particles is only once compressed per stroke, contrary to the present invention, in with which the material in particle form is compressed twice per stroke. The device according to the invention is operated without a spring system or without the employment of springs, and thus is much more economical compared to the well-known equipments. Another advantage of the device according to the invention is that the container is driven by an inhomogeneous motion, which results in a more harmonic wave-rich oscillation as compared to the known devices respectively processes.

Further preferred embodiments of the device according to the invention are exemplarily specified in the following part and are in no way intended to limit the subject-matter of the invention.

### EXAMPLE 1

Example 1 relates to an embodiment of the device according to the invention in which the pneumatic drive of the reciprocating piston is operated by means of an electronically synchronized magnetic valve. For the investigation of the characteristics of packings (compressed particle beds) investigations with steatite were accomplished. The steatite samples used here had a particle size within the range of from 125 to 160 μm. As container for receiving the particles, a tubular reactor was selected being approximately 300 mm long, whose lower end—according to the common proceedings known to the skilled person—was provided with a gas-permeable plug. The inner diameter of the tubular reactor was approximately 7 mm. Packing investigations were accomplished using stroke rates in the range between 200 and 1.200 strokes per minute.

### EXAMPLES 2 AND 3

Comparative particle compression investigations at the tubular reactor represented in the Example 1 were accomplished with a ramming volumeter and by means of ultrasonic excitation.

The variations in the height of the packed particle beds were substantially lower with the reactor packings manufactured by means of the device according to the invention than the variations in the height of the packed powder beds (particle beds), which were manufactured in accordance with the well-known processes. The relative deviations in the packing height of packings manufactured by means of the device according to the invention were at most 2%. To the contrary, the relative deviation of the packing height of packings manufactured by means of known devices were 5% and more. The packing height of the particle beds manufactured by means of the device according to the invention was at least 20 mm lower than the height of the beds (packings), which were manufactured according to known processes. As a result from it, it could be shown that the effectiveness of the compression by means of the device according to the invention is higher than the effectiveness of known processes respectively devices.

Besides, the time period for achieving a constant height of the particle packing was substantially less with the device according to the invention than with the known devices. In manufacturing particle packings using the same stroke rate, more stabile and more highly compressed particle packings could be manufactured within a third of the time period by means of the device according to the invention compared to particle packings manufactured in accordance to known processes.

The process according to the invention using the device according to the invention is to a considerable degree suitable for the simultaneous compression of several reactors filled with particles, which preferably can be moved as reactor bundles in parallel. Within short time periods, it is possible by means of an appropriately constructed stroke equipment to simultaneously compress the particle beds in a plurality of reactors. Besides, the reproducibility of compressed catalyst beds manufactured in this way is higher than those of beds manufactured in accordance to known processes.

In particular, the process is suitable for the production of compressed catalyst beds, with which the catalyst material in the form of particles is compressed together with, for example, inert material in the form of particles. The admixture of inert material to the catalyst material allows the dilution of the catalyst material to be tested. The inert material should possess similar characteristics concerning the density and the particle size distribution as compared to the catalyst material in order to exclude a particle separation during the compression process.

In performing catalytic test investigations it happens that the catalysts diluted with inert material are examined in uncompressed beds. Accordingly, it would be conceivable that the catalytic test data which are obtained in connection with the process according to the invention exhibit smaller deviations due to the high reproducibility in the manufacture of the catalyst packing as compared to those with which uncompressed catalyst beds are obtained.

In some technical applications compressed catalyst packings are used, which are in glass containers or ceramic containers. With special embodiments of the device for the particle compression according to the invention, it is possible that the particle beds are compressed in containers made of glass or ceramics. With these particular embodiments, the device according to the invention for example has flexible damping elements within the device respectively hulls of the containers, which prevent the cracking of the containers.

In another possible embodiment, the device according to the invention can be operated in a furnace. This may be advantageous if it is necessary to heat the materials in particle form to be compressed during the compression process. Moreover, the device according to the invention can be operated in a glove box, if the particles to be compressed should not be resistant against air.

For example, the material in particle form can be powdered material, and the particles can for example be powder.

Further characteristics of the invention are discussed in more detail at hand of embodiment examples which are shown in the figures. The figures:

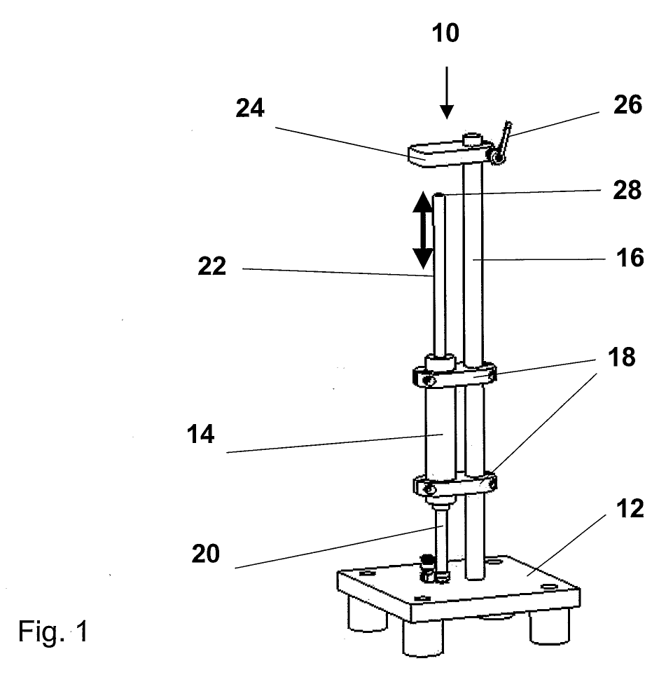

FIG. 1 is a schematic presentation of the device according to the invention for receiving one container, and

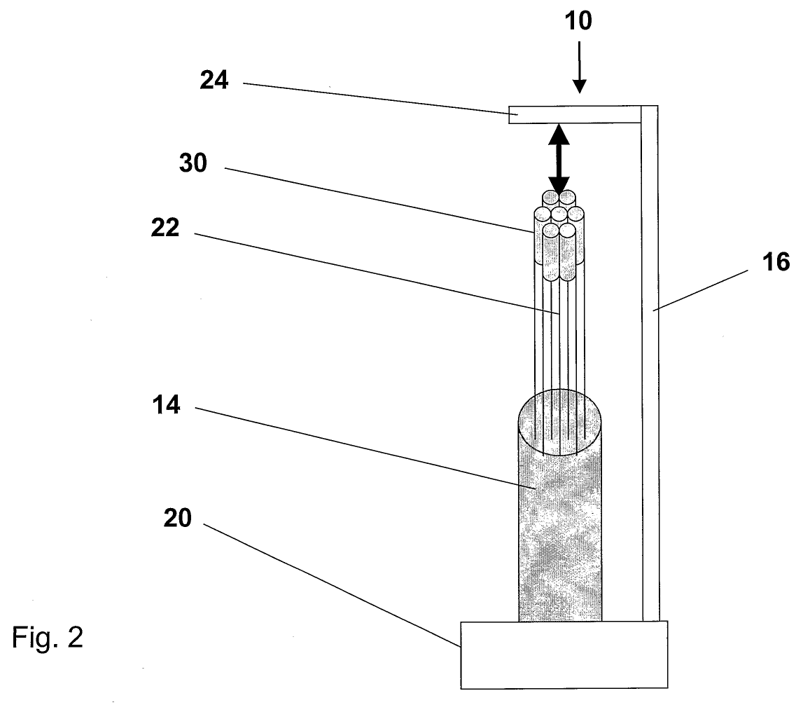

FIG. 2 is a schematic presentation of a device according to the invention for receiving several containers.

FIG. 1 shows a device 10 according to the invention having a container 22, which is guided vertically by a guiding device 14. The guiding device 14 is connected by means of two clamping elements 18 with a rod-shaped guidance 16. The clamping elements can linearly be shifted at the rod-shaped guidance 16 towards the longitudinal axis (rotation axis) of the rod-shaped guidance 16 and can be pivotally rotated around the longitudinal axis of the rod-shaped guidance 16. The rod-shaped guidance 16 is connected at the front side with a carrier unit 12.

A compression mechanism 20 is provided between guiding device 14 and carrier unit 12, which is vertically arranged in extension of the longitudinal axis of the guiding device 14. The compression equipment 20 can project on one side partially into the guiding device 14. After inserting the cylindrical container 22 into the likewise cylindrical recess of the guiding device 14, the container 22 rests on one side due to its gravity on a pneumatically operated reciprocating piston of the compression equipment 20. The rotation axes of the rotationally symmetric device components compression equipment 20, guiding device 14 and container 22 are preferably vertically aligned and congruent.

Furthermore, an arrester 24 is provided at the rod-shaped guidance 16, which is shiftable along the rod-shaped guidance 16 and is pivotable around the longitudinal axis of the rod-shaped guidance 16. For the adjustment of the position relative to the rod-shaped guidance 16, the arrester 24 has a fastening element 26. The plate-shaped arrester 24 is fixed in the operation mode at the rod-shaped guidance 16 with a distinct distance relating to the face 28 of the container 22. The distance is limited such that the container 22 strikes the arrester 24 in its vertical motion towards the arrester 24, still before it leaves the guidance device 14. Thus, it is ensured that during the compression process the container 22 is always supported respectively guided by the guiding device and does not leave said device. The container 22 is closed during the compression process, so that no particle can leave the container 22. For example, this is ensured by a closing which is provided at the front 28 which, however, is not represented in FIG. 1 in detail.

The control device 14 is preferably provided in the form of a cylindrical clamp which serves for receiving a container 22 filled with uncompressed particle beds, and which serves as guidance for the container 22 during the compression process. For the compression of the particle beds respectively for the manufacture of a compressed column-shaped particle packing, container 22 filled with particles is strongly accelerated by means of the linearly moving reciprocating piston of the compression equipment 20 along the cylindrical support (guiding device 14) so that the container is catapulted towards the arrester 24. Still before the container 22 filled with particles can completely withdraw from the cylindrical support (guiding device 14), it strikes arrester 24 with the face 28, rebounds from the arrester 24 and moves, due to the gravity and the recoil impulse exerted by the arrester 24 on the container 22, back into the cylindrical support (guiding device 14). In the cylindrical support (guiding device 14) the container 22 strikes the reciprocating piston of the compression equipment 20 and is again accelerated towards the arrester 24 by the movement thereof.

In FIG. 2, an embodiment of the device 10 according to the invention is shown for receiving several containers 22. Thereby, in this embodiment, each container 22 has a closing 30, respectively. In this embodiment, an arrester 24 more largely provided having an arrester surface, which preferably corresponds to the cross-section area of the guiding device 14, is fixed at a rod-shaped guidance 16. In this embodiment, a likewise more larger arranged compression equipment 20 replaces the carrier unit 12 provided in FIG. 1. In this embodiment, the compression equipment 20 serves for receiving both the rod-shaped guidance 16 and the guidance 14. The guiding device 14 can have a large recess for all containers for receiving the containers 22, or several small recesses for one container, respectively. The compression equipment 20 is arranged accordingly, which in case of a large recess of the guiding device 14 preferably has one reciprocating piston for all containers 22, or in case of several smaller recesses has one reciprocating piston per container 22, respectively. In the latter case, also the use of a reciprocating piston is conceivable, which has several projections, whose number and position correspond to those of the container 22.

### REFERENCE NUMERALS

10 device according to the invention
   12 carrier unit
14 guiding device
16 rod-shaped guidance
18 clamping element
20 compression equipment
22 container
24 arrester
26 fastening element
28 front side of a container 22
30 closing of a container 22

1. Device (10) for the manufacture of compressed particle beds having a container (22) for receiving materials in particle form, a guiding device (14) for the support and guidance of the container (22), and a compression equipment (20), wherein the compression equipment (20) has a reciprocating piston which is in effective connection with the container (22).

2. Device (10) according to claim 1, which further has an adjustable arrester (24).

3. Device (10) according to claim 1 or 2, which has one or more guiding devices (14) for several containers (22).

4. Device (10) according to any one of the preceding claims, wherein the compression equipment (20) has a reciprocating piston.

5. Device (10) according to any one of the preceding claims, wherein the compression mechanism (20) has one or more magnetic valves.

6. Device (10) according to any one of the preceding claims, wherein one container (22) each having a reciprocating piston, is in effective connection with a reciprocating piston, respectively, or wherein several containers (22) are in effective connection with a reciprocating piston.

7. Device (10) according to any one of the preceding claims, wherein the containers (22) have one or more closings (30).

8. Device (10) according to any one of the preceding claims, wherein the containers (22) are tubular reactors, which at least have one gas-permeable closing on one side.

9. Device (10) according to any one of the preceding claims, wherein the guiding device (14) has a closing.

10. Device (10) according to any one of the preceding claims, which has a data-processing system.

11. Device (10) according to any one of the preceding claims, wherein the particle size of the particles to be compressed is in the particle size range of from 4 μm to 5.000 μm, particularly preferred within the particle size range of from 40 μm to 600 μm.

12. Process for the manufacture of compressed particle beds comprising following steps:
(a) filling a container (22) with a first material in particle form,
(b) closing the container (22), and
(c) compressing the first material in particle form,
wherein a reciprocating piston exerts on the container (22) such that the container is accelerated in a guiding device (14) towards an arrester (24) and, after striking the arrester, moves back again towards the reciprocating piston.

13. Process as claimed in claim 12, wherein the course of motion of the container (22) is repeated according to a stroke rate until a pre-defined degree of compression of the first material in particle form is achieved.

14. Process as claimed in claim 12 or 13, wherein the steps (a) to (c) are repeated with one or more further materials in particle form.

15. Process as claimed in any one of claims 12 to 14, wherein the steps (a) to (c) are carried out with several containers (22) in parallel.

16. Process as claimed in any one of claims 12 to 15, wherein the reciprocating pistons realize a stroke rate within the range of from 200 to 1.200 strokes per minute.

17. Process as claimed in any one of claims 12 to 16, wherein energy exerting on the material in particle form is given by means of predetermined parameters.

18. Process as claimed in claim 17, wherein the parameter is selected from the group: motion rate of the piston, acceleration of the piston, frequency of the piston strokes, distance of container (22) to arrester (24), elasticity of the arrester material, container material and material of the reciprocating piston, total stroke number, stroke force of the piston.

19. Process as claimed in any one of claims 12 to 18, wherein the material in particle form in the container (22) is compressed by means of an inhomogeneous motion and/or a harmonic wave-rich oscillation.

20. Process as claimed in any one of claims 12 to 19, wherein the one or the more containers (22) having materials in the form of particles are automatedly transferred into the device and are removed from the device.

21. Computer program having program code means for operating or regulating the device according to any one of the claims 1 to 11, or for the realization of the process according to any one of the claims 12 to 20.

22. Data medium having a computer program according to claim 21.
